(19) United States
(12) Patent Application Publication
(10) Pub. No.: US 2019/0014362 A1
(43) Pub. Date: Jan. 10, 2019

(54) ENHANCED REGION-WISE PACKING AND VIEWPORT INDEPENDENT HEVC MEDIA PROFILE

(71) Applicant: QUALCOMM Incorporated, San Diego, CA (US)

(72) Inventors: Ye-Kui Wang, San Diego, CA (US); Thomas Stockhammer, Bergen (DE)

(21) Appl. No.: 16/030,585

(22) Filed: Jul. 9, 2018

Related U.S. Application Data
(60) Provisional application No. 62/530,525, filed on Jul. 10, 2017.
(60) Provisional application No. 62/532,698, filed on Jul. 14, 2017.

(51) Int. Cl. H04N 21/236; H04N 21/2343

(52) U.S. Cl. CPC H04N 21/23605; H04N 21/23439

(57) ABSTRACT

A device for processing media content can be configured to obtain, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked; unpack the first packed region to produce a first unpacked region; form a first projected region from the first unpacked region; unpack the second packed region to produce a second unpacked region; and form a second projected region from the second unpacked region, the second projected region being different than the first projected region.

This application claims the benefit of:

U.S. Provisional Application No. 62/530,525, filed Jul. 10, 2017, and
U.S. Provisional Application No. 62/532,698, filed Jul. 14, 2017
the entire content each of which is hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to processing media data and, more specifically to region-wise packing.

According to one example, a method of processing media content includes obtaining, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region; unpacking the first packed region to produce a first unpacked region; forming a first projected region from the first unpacked region; unpacking the second packed region to produce a second unpacked region; and forming a second projected region from the second unpacked region, the second projected region being different than the first projected region.

According to another example, a device for processing media content includes a memory configured to store media content; and one or more processors implemented in circuitry and configured to obtain, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region; unpack the first packed region to produce a first unpacked region; form a first projected region from the first unpacked region; unpack the second packed region to produce a second unpacked region; and form a second projected region from the second unpacked region, the second projected region being different than the first projected region.

According to another example, a computer-readable storage medium having stored thereon instructions that, when executed, cause a processor to obtain, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region; unpack the first packed region to produce a first unpacked region; form a first projected region from the first unpacked region; unpack the second packed region to produce a second unpacked region; and form a second projected region from the second unpacked region, the second projected region being different than the first projected region.

According to another example, a device for processing media includes means for obtaining, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region; means for unpacking the first packed region to produce a first unpacked region; means for forming a first projected region from the first unpacked region; means for unpacking the second packed region to produce a second unpacked region; and means for forming a second projected region from the second unpacked region, the second projected region being different than the first projected region.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of a retrieval unit.

FIG. 3 is a conceptual diagram illustrating two examples of region-wise packing (RWP) for Omnidirectional Media Format (OMAF).

FIG. 4 is a conceptual diagram illustrating elements of example multimedia content.

FIG. 5 is a block diagram illustrating elements of an example video file.

FIG. 6 is a flowchart illustrating an example method of receiving and processing video data in accordance with the techniques of this disclosure.

### DETAILED DESCRIPTION

The techniques of this disclosure may be applied to video files conforming to video data encapsulated according to any of ISO base media file format (ISOBMFF), extensions to ISOBMFF, Scalable Video Coding (SVC) file format, Advanced Video Coding (AVC) file format, High Efficiency Video Coding (HEVC) file format, Third Generation Partnership Project (3GPP) file format, and/or Multiview Video Coding (MVC) file format, or other video file formats. A draft of ISO BMFF is specified in ISO/IEC 14496-12, available from phenix.int-evry.fr/mpeg/doc_end_user/documents/111_Geneva/wg11/w15177-v6-w15177.zip. A draft of another example file format, MPEG-4 file format, is specified in ISO/IEC 14496-15, available from wg11.sc29.org/doc_end_user/documents/115_Geneva/wg11/w16169-v2-w16169.zip.

ISOBMFF is used as the basis for many codec encapsulation formats, such as the AVC file format, as well as for many multimedia container formats, such as the MPEG-4 file format, the 3GPP file format (3GP), and the digital video broadcasting (DVB) file format.

In addition to continuous media, such as audio and video, static media, such as images, as well as metadata can be stored in a file conforming to ISOBMFF. Files structured according to the ISOBMFF may be used for many purposes, including local media file playback, progressive downloading of a remote file, segments for Dynamic Adaptive Streaming over HTTP (DASH), containers for content to be streamed and its packetization instructions, and recording of received real-time media streams.

A box is an elementary syntax structure in ISOBMFF, including a four-character coded box type, the byte count of the box, and the payload. An ISOBMFF file includes a sequence of boxes, and boxes may contain other boxes. According to ISOBMFF, a Movie box (“moov”) contains the metadata for the continuous media streams present in the file, each one represented in the file as a track. Per ISOBMFF, metadata for a track is enclosed in a Track box (“trak”), while the media content of a track is either enclosed in a Media Data box (“mdat”) or provided directly in a separate file. The media content for tracks includes a sequence of samples, such as audio or video access units.

ISOBMFF specifies the following types of tracks: a media track, which contains an elementary media stream, a hint track, which either includes media transmission instructions or represents a received packet stream, and a timed metadata track, which comprises time-synchronized metadata.

Although originally designed for storage, the ISOBMFF has proven to be very valuable for streaming, e.g., for progressive download or DASH. For streaming purposes, movie fragments defined in ISOBMFF can be used.

The metadata for each track includes a list of sample description entries, each providing the coding or encapsulation format used in the track and the initialization data needed for processing that format. Each sample is associated with one of the sample description entries of the track.

The ISOBMFF enables specifying sample-specific metadata with various mechanisms. Specific boxes within the Sample Table box (“stbl”) have been standardized to respond to common needs. For example, a Sync Sample box (“stss”) is used to list the random access samples of the track. The sample grouping mechanism enables mapping of samples according to a four-character grouping type into groups of samples sharing the same property specified as a sample group description entry in the file. Several grouping types have been specified in the ISOBMFF.

Virtual reality (VR) is the ability to be virtually present in a virtual, non-physical world created by the rendering of natural and/or synthetic images and sounds correlated by movements of an immersed user, allowing interaction with that virtual world. With recent progress made in rendering devices, such as head mounted displays (HMD) and VR video (often also referred to as 360-degree video) creation, a significant quality of experience can be offered. VR applications include gaming, training, education, sports video, online shopping, entrainment, and so on.

A typical VR system includes the following components and performs the following steps:
1) A camera set, which typically includes multiple individual cameras pointing in different directions, ideally collectively covering all viewpoints around the camera set.
2) Image stitching, where video pictures taken by the multiple individual cameras are synchronized in the time domain and stitched in the space domain, to be a spherical video, but mapped to a rectangular format, such as equi-rectangular (like a world map) or cube map.
3) The video in the mapped rectangular format is encoded/compressed using a video codec, e.g., H.265/HEVC or H.264/AVC.
4) The compressed video bitstream(s) may be stored and/or encapsulated in a media format and transmitted (possibly only the subset covering the area being seen by a user, sometimes referred to as the viewport) through a network to a receiving device (e.g., a client device).
5) The receiving device receives the video bitstream(s) or part thereof, possibly encapsulated in a file format, and sends the decoded video signal or part thereof to a rendering device (which may be included in the same client device as the receiving device).
6) The rendering device can be, e.g., a head mounted display (HMD), which can track head movement and even eye movement, and may render the corresponding part of the video such that an immersive experience is delivered to the user.

Omnidirectional MediA Format (OMAF) is being developed by the Moving Pictures Experts Group (MPEG) to define a media format that enables omnidirectional media applications, focusing on VR applications with 360-degree video and associated audio. OMAF specifies a list of projection methods that can be used for conversion of a spherical or 360-degree video into a two-dimensional rectangular video, followed by how to store omnidirectional media and the associated metadata using the ISO base media file format (ISOBMFF) and how to encapsulate, signal, and stream omnidirectional media using dynamic adaptive streaming over HTTP (DASH), and finally, which video and audio codecs, as well as media coding configurations, can be used for compression and playback of the omnidirectional media signal. OMAF is to become ISO/IEC 23090-2, and a draft specification is available from wg11.sc29.org/doc_end_user/documents/119_Torino/wg11/m40849-v1-m40849_OMAF_text_Berlin_output.zip.

In HTTP streaming protocols, such as DASH, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

DASH is specified in ISO/IEC 23009-1, and is a standard for HTTP (adaptive) streaming applications. ISO/IEC 23009-1 mainly specifies the format of the media presentation description (MPD), also known as a manifest or manifest file, and media segment formats. The MPD describes the media available on a server and allows a DASH client to autonomously download an appropriate media version at an appropriate media time.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

A typical procedure for DASH based HTTP streaming includes the following steps:
1) A DASH client obtains the MPD of a streaming content, e.g., a movie. The MPD includes information on different alternative representations, e.g., bit rate, video resolution, frame rate, audio language, of the streaming content, as well as URLs of the HTTP resources (the initialization segment and the media segments).
2) Based on information in the MPD and local information available to the DASH client, e.g., network bandwidth, decoding/display capabilities, and user preferences, the DASH client requests the desired representation(s), one segment (or a part thereof) at a time.
3) When the DASH client detects a network bandwidth change, it requests segments of a different representation with a better-matching bitrate, ideally starting from a segment that starts with a random access point.

During an HTTP streaming “session,” to respond to a user request to seek backward to a past position or forward to a future position, the DASH client requests past or future segments starting from a segment that is close to the desired position and that ideally starts with a random access point. The user may also request to fast-forward the content, which may be realized by requesting data sufficient for decoding only intra-coded video pictures or only a temporal subset of the video stream.

Section 5.3.3.1 of the DASH specification describes Preselection as follows:

The concept of Preselection is primarily motivated for the purpose of Next Generation Audio (NGA) codecs in order to signal suitable combinations of audio elements that are offered in different Adaptation Sets. However, the Preselection concept is introduced in a generic manner such that it can be extended and be used also for other media types and codecs.

Each Preselection is associated to a bundle. A bundle is a set of elements which may be consumed jointly by a single decoder instance. Elements are addressable and separable components of a bundle and may be selected or deselected dynamically by the application, either directly or indirectly by the use of Preselections. Elements are mapped to Adaptation Sets by either a one-to-one mapping or by the inclusion of multiple elements in a single Adaptation Sets. Furthermore, Representations in one Adaptation Set may contain multiple elements that are multiplexed on elementary stream level or on file container level. In the multiplexing case each element is mapped to a Media Content component as defined in DASH Section 5.3.4. Each element in the bundle is therefore identified and referenced by the @id of a Media Content component, or, if only a single element is contained in the Adaptation Set, by the @id of an Adaptation Set.

Each bundle includes a main element that contains the decoder specific information and bootstraps the decoder. The Adaptation Set that contains the main element is referred to as main Adaptation Set. The main element shall always be included in any Preselection that is associated to a bundle. In addition, each bundle may include one or multiple partial Adaptation Sets. Partial Adaptation Sets may only be processed in combination with the main Adaptation Set.

A Preselection defines a subset of elements in a bundle that are expected to be consumed jointly. A Preselection is identified by a unique tag towards the decoder. Multiple Preselection instances can refer to the same set of streams in a bundle. Only elements of the same bundle can contribute to the decoding and rendering of a Preselection.

In the case of next generation audio, a Preselection is a personalization option that is associated with one or more audio elements from one plus additional parameters like gain, spatial location to produce a complete audio experience. A Preselection can be considered the NGA-equivalent of alternative audio tracks containing complete mixes using traditional audio codecs.

A bundle, Preselection, main element, main Adaptation Set and partial Adaptation Sets may be defined by one of the two means:
A preselection descriptor is defined in DASH Section 5.3.11.2. Such a descriptor enables simple setups and backward compatibility, but may not be suitable for advanced use cases.
A preselection element as defined in DASH Sections 5.3.11.3 and 5.3.11.4. The semantics of the Preselection element is provided in Table 17c in DASH Section 5.3.11.3, the XML syntax is provided in DASH Section 5.3.11.4.

The instantiation of the introduced concepts using both methods is provided in the following.

In both cases, if the Adaptation Set is not including the main Adaptation Set, then the Essential descriptor shall be used together with the @schemeIdURI as defined in DASH Section 5.3.11.2.

The DASH specification also describes a preselection descriptor, as follows:

A scheme is defined to be used with an Essential Descriptor as “urn:mpeg:dash:preselection:2016”. The value of the Descriptor provides two fields, separated by a comma:
the tag of the Preselection
the id of the contained elements/content components of this Preselection list as white space separated list in processing order. The first id defines the main element.

If the Adaptation Set includes the main element, then the Supplemental descriptor may be used to describe contained Preselections in the Adaptation Set.

If the Adaptation Set does not contain the main element then the Essential Descriptor shall be used.

The bundle is inherently defined by all elements that are included in all Preselections that include the same main element. Preselections are defined by the metadata that is assigned to each of the elements that are included in the Preselection. Note that this signaling may be simple for basic use cases but is expected to not provide a full coverage for all use cases. Therefore, the Preselection element is introduced in DASH Section 5.3.11.3 to cover more advanced use cases.

The DASH specification also describes semantics of a preselection element, as follows:

As an extension to the Preselection descriptor, Preselections may also be defined through the Preselection element as provided in Table 17d. The selection of Preselections is based on the contained attributes and elements in the Preselection element.

TABLE 17d
of DASH - Semantics of PreSelection element

| Element or Attribute Name | | |
|---|---|---|
| Preselection | Use | Description |
| @id | OD default = 1 | specifies the id of the Preselection. This shall |
| | | be unique within one Period. |
| @preselectionComponents | 1 | specifies the ids of the contained |
| | | elements/content components of this |
| | | Preselection list as white space separated list |
| | | in processing order. The first id defines the |
| | | main element. |
| Language | 0 . . . N | declares a language code for this |
| | | Preselection. The syntax and semantics |
| | | according to IETF RFC 5646 shall be used. |
| | | If not present, the language code may be |
| | | defined for each media component or it may |
| | | be unknown. |
| Role | 0 . . . N | describes the Role of the Preselection. For |
| | | more details refer to 5.8.4.2. |
| Accessibility | 0 . . . N | Describes the accessibility features of the |
| | | Preselection. For more details refer to |
| | | 5.8.4.3. |
| Accessibility | 0 . . . N | specifies information about accessibility scheme |
| | | For more details refer to 5.8.1 and 5.8.4.3. |
| Role | 0 . . . N | specifies information on role annotation scheme |
| | | For more details refer to 5.8.1 and 5.8.4.2. |
| Rating | 0 . . . N | specifies information on rating scheme. |
| | | For more details refer to 5.8.1 and 5.8.4.4. |
| Viewpoint | 0 . . . N | specifies information on viewpoint |
| | | annotation scheme. |
| | | For more details refer to 5.8.1 and 5.8.4.5. |
| [symbol] | — | specifies the common attributes and elements |
| [symbol] | | (attributes and elements from base type |
| | | [symbol] . For details see 5.3.7. |

Legend:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and preceded with an @.

With respect to Frame Packing, Section 5.8.4.6 of DASH specifies Preselection as follows:

For the element FramePacking the @schemeIdUri attribute is used to identify the frame-packing configuration scheme employed.

Multiple FramePacking elements may be present. If so, each element shall contain sufficient information to select or reject the described Representations.

NOTE if the scheme or the value for all FramePacking elements are not recognized the DASH client is expected to ignore the described Representations. A client may reject the Adaptation Set on the basis of observing a FramePacking element.

The descriptor may carry frame-packing schemes using the URN label and values defined for VideoFramePackingType in ISO/IEC 23001-8.

NOTE: This part of ISO/IEC 23009 also defines frame-packing schemes in DASH Section 5.8.5.6. These schemes are maintained for backward-compatibility, but it recommended to use the signalling as defined in ISO/IEC 23001-8.

Video data may be encoded according to a variety of video coding standards. Such video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 or ISO/IEC MPEG-4 AVC, including its Scalable Video Coding (SVC) and Multiview Video Coding (MVC) extensions, and High-Efficiency Video Coding (HEVC), also known as ITU-T H.265 and ISO/IEC 23008-2, including its scalable coding extension (i.e., scalable high-efficiency video coding, SHVC) and multiview extension (i.e., multiview high efficiency video coding, MV-HEVC).

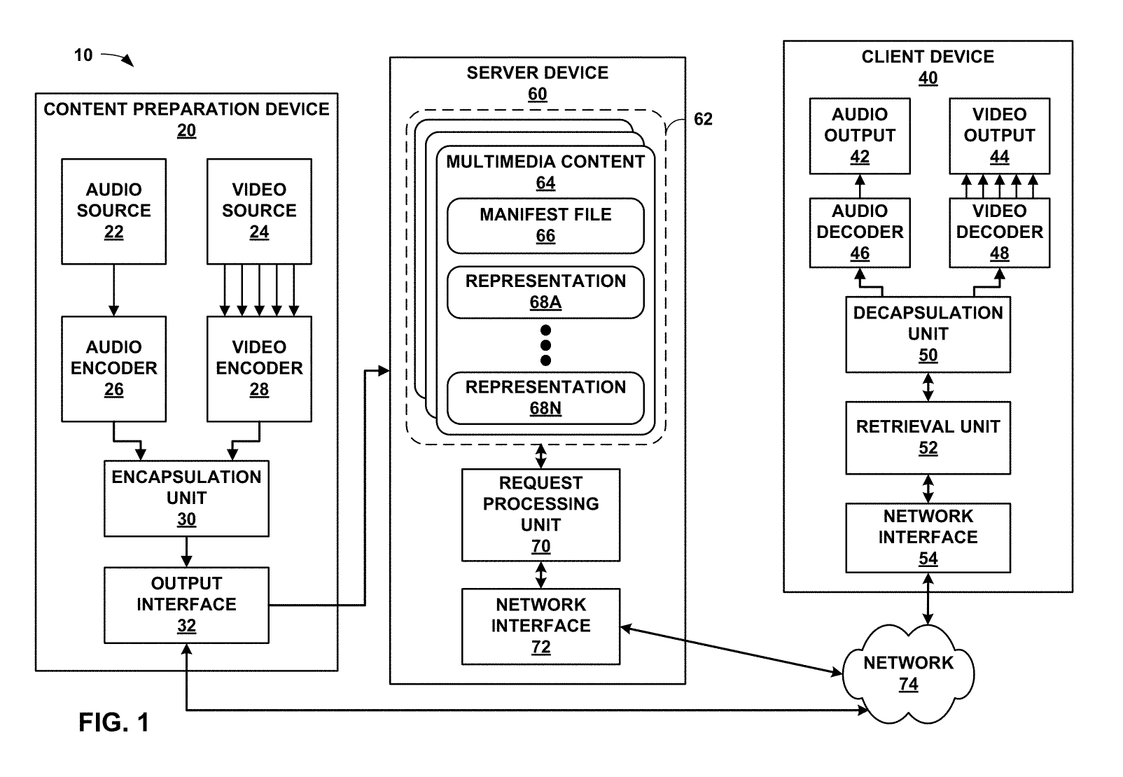

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

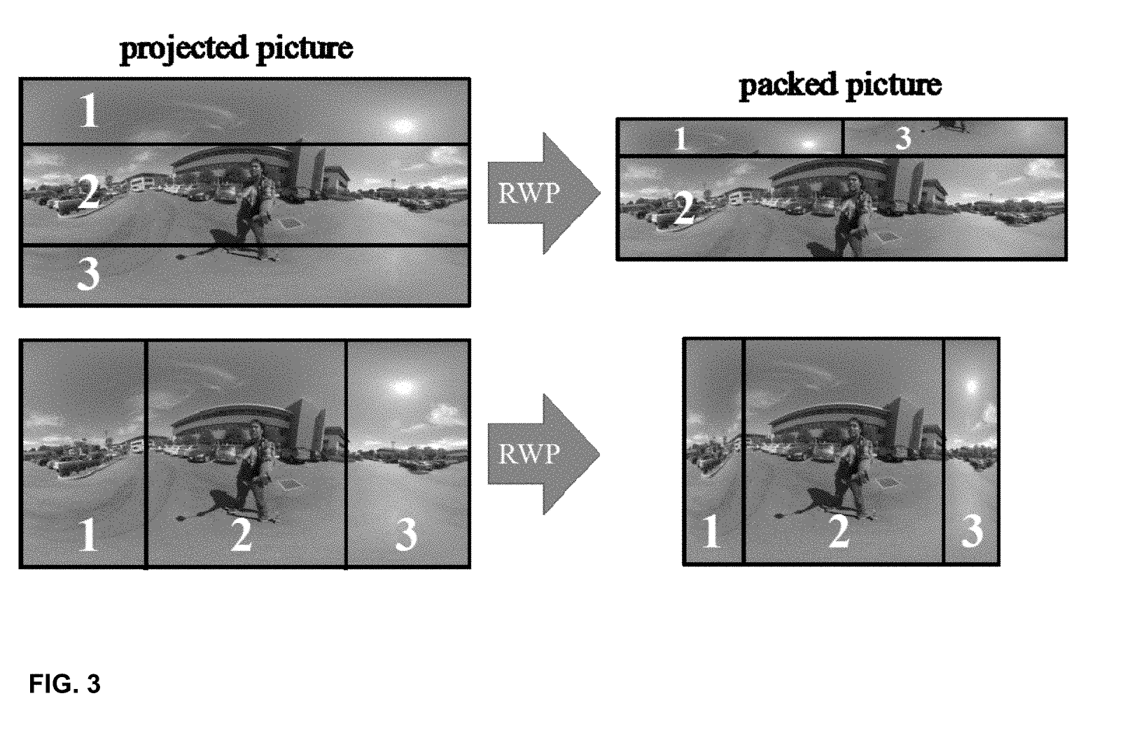

Content preparation device 20 may obtain spherical video data using video source 24, e.g., by capturing and/or generating (e.g., rendering) the spherical video data. The spherical video data may also be referred to as projected video data. Content preparation device 20 may form packed video data from the projected video data (or spherical video data) for ease of encoding, processing, and transport. An example is shown in FIG. 3 below. Content preparation device 20 may generate a region-wise packing box (RWPB) that defines positions and sizes of the various packed regions in the manner described above.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Content preparation device 20 and/or server device 60 may be configured to determine boundaries of packed regions, and set values for packed_reg_width[i], packed_reg_height[i], packed_reg_top[i], and packed_reg_left[i] accordingly. Likewise, client device 40 may determine the boundaries (and therefore, sizes and positions) of packed regions from the values of packed_reg_width[i], packed_reg_height[i], packed_reg_top[i], and packed_reg_left[i], described in more detail below.

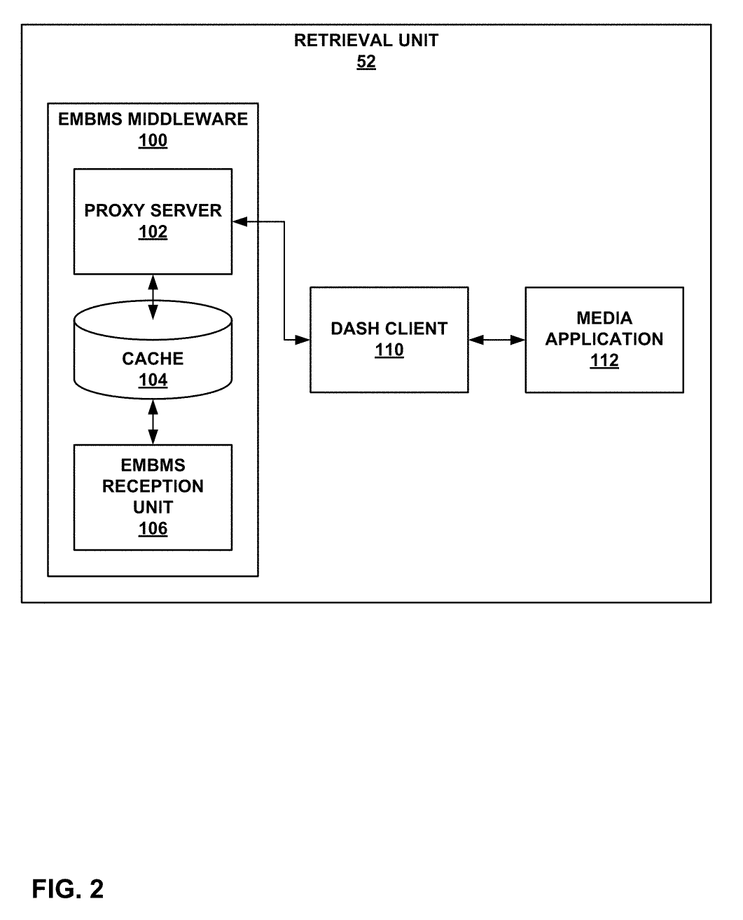

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE—File Delivery over Unidirectional Transport,” Network Working Group, RFC 6726, November 2012, available at tools.ietf.org/html/rfc6726. That is, eMBMS reception unit 106 may receive files via broadcast from, e.g., server device 60, which may act as a BM-SC.

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server unit 102 using HTTP GET or partial GET requests. For example, for a segment available from link 127.0.0.1/rep1/seg3, DASH client 110 may construct an HTTP GET request that includes a request for 127.0.0.1/rep1/seg3, and submit the request to proxy server unit 102. Proxy server unit 102 may retrieve requested data from cache 104 and provide the data to DASH client 110 in response to such requests.

FIG. 3 is a conceptual diagram illustrating two examples of region-wise packing (RWP) for OMAF. OMAF specifies a mechanism called region-wise packing (RWP). RWP enables manipulations (resize, reposition, rotation, and mirroring) of any rectangular region of a projected picture. RWP can be used to generate an emphasis on a specific viewport orientation or circumvent weaknesses of projections, such as oversampling towards the poles in ERP. The latter is depicted in the example at the top of FIG. 3 where the areas near the poles of the sphere video are reduced in resolution. The example at the bottom of FIG. 3 depicts an emphasized viewport orientation.

The existing design of region-wise packing in the latest OMAF draft specification and the viewport independent HEVC media profile in N16826 may have several potential problems. A first potential problem is that if the content (i.e., packed picture) does not cover the entire sphere, the RWP box must be present. However, the techniques of this disclosure include enabling sub-sphere content without using RWP. In the viewport independent HEVC media profile in N16826, the presence of the RWP box is disallowed. Consequently, this media profile as specified would not support sub-sphere contents.

A second potential problem, related to the first potential problem is that the width and height of the projected picture are signalled in the RWP box. Thus, if this box is not present, the size is not signaled, and the only option is to assume the size to be the width and height syntax elements of VisualSampleEntry, which are the size of the packed picture. As a third potential problem, based on the two potential problems introduced above, it can be concluded that, when actual RWP operations like re-sizing, re-positioning, rotation, and mirroring are not needed, and when guard band is not needed either, for a sub-sphere content, the role of the RWP box is just to tell the size of the projected picture, and which region of the projected picture corresponds to the packed picture. However, only for this purpose, signalling of just the size of the projected picture, and the horizontal and vertical offset of the upper left corner luma sample of the packed picture relative to the upper left corner luma sample of the packed picture would be sufficient. All the other syntax elements in the RWP boxes would not be needed and the data for those can be saved.

A fourth potential problem is that for adaptive streaming, one video content is usually encoded into multiple bitstreams with different bandwidths and typically also different spatial resolutions. Because the units of the signaled projected and packed regions are all in luma sample, in the case of different spatial resolutions for the same video content, the encoder would need to figure out different RWP schemes for different spatial resolutions, and each spatial resolution would need a separate RWP signaling.

As a fifth potential problem, in the entire conversion process from the location of a luma sample of the decoded picture, via the corresponding luma sample location in the projected picture, to the corresponding location (the angular coordinates) on the sphere of the global coordinate axes, the 2D Cartesian coordinates (i, j) or (xProjPicture and yProjPicture) on the projected picture need to be fixed-point values, not integers.

A sixth potential problem is that from the point of view of the decoder/render side, the projected picture is just a concept, as no process is specified to generate the sample values of the projected picture, nor is it needed. Based on the fourth, fifth, and sixth problems, this disclosure describes techniques for specifying the units of the size of the projected picture and the size and position of projected and packed regions in relative units. This way, in the case of different spatial resolutions for the same video content, the encoder would not need to figure out different RWP schemes for different spatial resolutions, and one RWP signaling would be applicable to all alternative bitstream of the same video content.

As a seventh potential problem, the container of the RWP box is the Scheme Information box, while the container of other projected omnidirectional video specific boxes like coverage and orientation is the Projected Omnidirectional Video box. This would make checking and verifying the correctness of the relationship between the RWP box and other omnidirectional video specific information more complicated.

This disclosure introduces potential solutions to the above-described problems. The various techniques described herein may be applied independently or in various combinations.

A first technique described in this disclosure is to add a version 1 of the RWP box that provides only the size of the projected picture and the position offsets of the packed picture relative to the projected picture. According to a first example, it is proposed to add a version 1 of the RWP box. When the projected picture is monoscopic, the RWP box provides only the size of the projected picture and the position offsets of the packed picture relative to the projected picture. When the projected picture is stereoscopic using side-by-side or top-bottom frame packing, the RWP box provides only the size of the projected picture and the position offsets of each packed picture part belonging to one view relative to the projected picture part belonging to the same view. According to a second example, it is proposed to signal the same information as version 1 of the RWP box using another means. For example, define a new box that can be included into the Projected Omnidirectional Video box or the Scheme Information box, and restrict that only either the new box or the RWP box can be present but not both.

A second technique of this disclosure includes the viewport independent HEVC media profile being required to support version 1 of the RWP box for support of sub-sphere contents without region-wise re-sizing, re-positioning, rotation, and mirroring. In other examples, the presence of version 0 of the RWP box may be allowed, but when present, the values of the syntax elements in the RWP box are restricted such that only the information same as version 1 of the RWP box is conveyed by the box.

According to a third technique of this disclosure, for all versions of the RWP box, the sizes and position offsets of the projected picture, packed picture, projected regions, and packed regions are specified in relative units instead of absolute units of luma samples. According to a fourth technique of this disclosure, the container of the RWP box from the Scheme Information box may be changed to the Projected Omnidirectional Video box.

A more detailed implementation of the first technique will now be described. Changes to the syntax and semantics of the RWP box are shown below. The syntax and semantics of the region-wise packing box may be changed as follows (where bold highlights are additions and [[brackets]] represent removals. Other parts remain unchanged)

The syntax can be changed as follows:

```
aligned(8) class RegionWisePackingBox extends FullBox(‘rwpk’,
version[[0]], 0) {
  unsigned int(16) proj_picture_width;
  unsigned int(16) proj_picture_height;
  if (version == 0)
    RegionWisePackingStruct( );
  else if (version == 1) {
    unsigned int(16) proj_picture_voffset;
    unsigned int(16) proj_picture_hoffset;
  }
}
aligned(8) class RegionWisePackingStruct {
  unsigned int(8) num_regions;
  [[unsigned int(16) proj_picture_width;]]
  [[unsigned int(16) proj_picture_height;]]
  for (i = 0; i < num_regions; i++) {
    bit(3) reserved = 0;
    unsigned int(1) guard_band_flag[i];
    unsigned int(4) packing_type[i];
    if (packing_type[i] == 0) {
      RectRegionPacking(i);
      if (guard_band_flag[i]) {
        unsigned int(8) left_gb_width[i];
        unsigned int(8) right_gb_width[i];
        unsigned int(8) top_gb_height[i];
        unsigned int(8) bottom_gb_height[i];
        unsigned int(1) gb_not_used_for_pred_flag[i];
        unsigned int(3) gb_type[i];
        bit(4) reserved = 0;
      }
    }
  }
}
aligned(8) class RectRegionPacking(i) {
  unsigned int(16) proj_reg_width[i];
  unsigned int(16) proj_reg_height[i];
  unsigned int(16) proj_reg_top[i];
  unsigned int(16) proj_reg_left[i];
  unsigned int(3) transform_type[i];
  bit(5) reserved = 0;
  unsigned int(16) packed_reg_width[i];
  unsigned int(16) packed_reg_height[i];
  unsigned int(16) packed_reg_top[i];
  unsigned int(16) packed_reg_left[i];
}
```

The semantics can be changed as follows:
proj_picture_width and proj_picture_height specify the width and height, respectively, of the projected picture, in units of luma samples. proj_picture_width and proj_picture_height shall both be greater than 0.
proj_picture_voffset and proj_picture_hoffset specify the vertical offset and the horizontal offset, respectively, of the packed picture in the projected picture, in units of luma samples. The values shall be in the range from 0, inclusive, indicating the top-left corner of the projected picture, to proj_picture_height−PackedPicHeight−1, inclusive, and proj_picture_width−PackedPicWidth−1, inclusive, respectively.
num_regions specifies the number of packed regions. Value 0 is reserved.
. . .
packed_reg_width[i], packed_reg_height[i], packed_reg_top[i] and packed_reg_left[i] are indicated in units of luma samples in a packed picture with width and height equal to PackedPicWidth and PackedPicHeight, respectively.
packed_reg_width[i], packed_reg_height[i], packed_reg_top[i], and packed_reg_left[i] specify the width, height, the top luma sample row, and the left-most luma sample column, respectively, of the packed region in the packed picture.
. . .

The following describes changes to the mapping of a sample locations within a decoded picture to angular coordinates relative to the global coordinate axes. Clause 7.2.2.2 of the latest OMAF draft specification is changed as follows (where bold highlights represent additions, and [[brackets]] represent removals. The other parts remain unchanged. Section 7.2.2.2 Mapping of luma sample locations within a decoded picture to angular coordinates relative to the global coordinate axes is changed as follows:

The width and height of a monoscopic projected luma picture (pictureWidth and pictureHeight, respectively) are derived as follows:
The variables HorDiv and VerDiv are derived as follows:
   If StereoVideoBox is absent, HorDiv and VerDiv are set equal to 1.
   Otherwise, if StereoVideoBox is present and indicates side-by-side frame packing, HorDiv is set equal to 2 and VerDiv is set equal to 1.
   Otherwise (StereoVideoBox is present and indicates top-bottom frame packing), HorDiv is set equal to 1 and VerDiv is set equal to 2.
If RegionWisePackingBox is absent, pictureWidth and pictureHeight are set to be equal to width/HorDiv and height/VerDiv, respectively, where width and height are syntax elements of VisualSampleEntry.
Otherwise, pictureWidth and pictureHeight are set equal to prof_picture_width/HorDiv and prof_picture_height/VerDiv, respectively.
   If RegionWisePackingBox with version equal to 0 is present, the following applies for each packed region n in the range of 0 to num_regions−1, inclusive:
For each sample location (xPackedPicture, yPackedPicture) belonging to the n-th packed region with packing_type[n] equal to 0 (i.e., with rectangular region-wise packing), the following applies:
   The corresponding sample location (xProjPicture, yProjPicture) of the projected picture is derived as follows:
      x is set equal to xPackedPicture−packed_reg_left[n].
      y is set equal to yPackedPicture−packed_reg_top[n].
      offsetX is set equal to 0.5.
      offsetY is set equal to 0.5.
      Clause 5.4 is invoked with x, y, packed_reg_width[n], packed_reg_height[n], proj_reg_width[n], proj_reg_height[n], transform_type[n], offsetX and offsetY as inputs, and the output is assigned to sample location (i, j).
      xProjPicture is set equal to proj_reg_left[n]+i.
      yProjPicture is set equal to proj_reg_top[n]+j.
   Clause 7.2.2.3 is invoked with xProjPicture, yProjPicture, pictureWidth, and pictureHeight as inputs, and the outputs indicating the angular coordinates and the constituent frame index (for frame-packed stereoscopic video) for the luma sample location (xPackedPicture, yPackedPicture) belonging to the n-th packed region in the decoded picture.
      Otherwise, the following applies for each sample location (x, y) within the decoded picture:
If RegionWisePackingBox with version equal to 1 is present, hOffset is set equal to proj_picture_hoffset, and vOffset is set equal to proj_picture_voffset.
Otherwise, hOffset and vOffset are both set equal to 0.
xProjPicture is set equal to x+hOffset+0.5.
yProjPicture is set equal to y+vOffset+0.5.
Clause 7.2.2.3 is invoked with xProjPicture, yProjPicture, pictureWidth, and pictureHeight as inputs, and the outputs indicating the angular coordinates and the constituent frame index (for frame-packed stereoscopic video) for the luma sample location (x, y) within the decoded picture.

A more detailed implementation of the first example of the first technique will now be described. The syntax of the region-wise packing box is same as the above example 1. The semantics of the region-wise packing box are changed relative to the latest OMAF draft specification text as follows (where bold highlights represent additions and [[brackets]] represent removals. The other parts remain unchanged.
proj_picture_width and proj_picture_height specify the width and height, respectively, of the projected picture, in units of luma samples. proj_picture_width and proj_picture_height shall both be greater than 0.
proj_picture_voffset and proj_picture_hoffset are used to infer the values of proj_reg_top[i] and proj_reg_left[i] when version is equal to 1.
When version is equal to 1, the values of the variables HorDiv1 and VerDiv1 are set as follows:
   If StereoVideoBox is not present, HorDiv1 is set equal to 1 and VerDiv1 is set equal to 1.
   Otherwise (StereoVideoBox is present), the following applies:
      If side-by-side frame packing is indicated, HorDiv1 is set equal to 2 and VerDiv1 is set equal to 1.
      Otherwise (top-bottom frame packing is indicated), HorDiv1 is set equal to 1 and VerDiv1 is set equal to 2.
num_regions specifies the number of packed regions. Value 0 is reserved. When version is equal to 1, the value of num_regions is inferred to be equal to HorDiv1*VerDiv1.
guard_band_flag[i] equal to 0 specifies that the i-th packed region does not have a guard band. guard_band_flag[i] equal to 1 specifies that the i-th packed region has a guard band. When version is equal to 1, the value of guard_band_flag[i] is inferred to be equal to 0.
packing_type[i] specifies the type of region-wise packing. packing_type[i] equal to 0 indicates rectangular region-wise packing. Other values are reserved. When version is equal to 1, the value of packing_type[i] is inferred to be equal to 0.
. . .
proj_reg_width[i] specifies the width of the i-th projected region. proj_reg_width[i] shall be greater than 0. When version is equal to 1, the value of proj_reg_width[i] is inferred to be equal to PackedPicWidth/HorDiv1.
proj_reg_height[i] specifies the height of the i-th projected region. proj_reg_height[i] shall be greater than 0. When version is equal to 1, the value of proj_reg_height[i] is inferred to be equal to PackedPicHeight/VerDiv1.
proj_reg_top[i] and proj_reg_left[i] specify the top luma sample row and the left-most luma sample column, respectively, of the i-th projected region in the projected picture. The values shall be in the range from 0, inclusive, indicating the top-left corner of the projected picture, to prof_picture_height−1, inclusive, and prof_picture_width−1, inclusive, respectively. When version is equal to 1, the value of proj_reg_top[i] is inferred to be equal to proj_picture_voffset+i*proj_picture_height*(1−1/VerDiv1), and the value of proj_reg_left[i] is inferred to be equal to proj_picture_hoffset+i*proj_picture_width*(1−1/HorDiv1).
. . .
transform_type[i] specifies the rotation and mirroring that have been applied to the i-th projected region to map it to the packed picture before encoding. When version is equal to 0, the value of transform_type[i] is inferred to be equal to 0. When transform_type[i] specifies both rotation and mirroring, rotation has been applied after mirroring in the region-wise packing from the projected picture to the packed picture before encoding . . . .
. . .
packed_reg_width[i], packed_reg_height[i], packed_reg_top[i] and packed_reg_left[i] are indicated in units of luma samples in a packed picture with width and height equal to PackedPicWidth and PackedPicHeight, respectively.
packed_reg_width[i], packed_reg_height[i], packed_reg_top[i], and packed_reg_left[i] specify the width, height, the top luma sample row, and the left-most luma sample column, respectively, of the packed region in the packed picture.
When version is equal to 1, the values of packed_reg_width[i], packed_reg_height[i], packed_reg_top[i] and packed_reg_left[i] are inferred to be equal to PackedPicWidth/HorDiv1, PackedPicHeight/VerDiv1,i*PackedPicHeight*(1−1/VerDiv1), and i*PackedPicWidth*(1−1/HorDiv1), respectively.
. . .

A more detailed implementation of the second technique will now be described. According to one implementation, the following sentence in the definition of the viewport independent HEVC media profile

“RegionWisePackingBox shall not be present in SchemeInformationBox.” can be replaced with:

“When the region-wise packing box is present, the version of the box shall be equal to 1.”

In a version of the second technique that allows the presence of version 0 of the RWP box, but when present, restricts the values of the syntax elements in the RWP box such that only the information same as version 1 of the RWP box is conveyed by the box, the following sentence in the definition of the viewport independent HEVC media profile

RegionWisePackingBox shall not be present in SchemeInformationBox. may be replaced with:

The values of the variables HorDiv1 and VerDiv1 are set as follows:
If StereoVideoBox is not present, HorDiv1 is set equal to 1 and VerDiv1 is set equal to 1.
Otherwise (StereoVideoBox is present), the following applies:
   If side-by-side frame packing is indicated, HorDiv1 is set equal to 2 and VerDiv1 is set equal to 1.
   Otherwise (top-bottom frame packing is indicated), HorDiv1 is set equal to 1 and VerDiv1 is set equal to 2.

When the region-wise packing box is present, the following constraints all apply:
The value of num_regions shall be equal to HorDiv1*VerDiv1.
For each value of i in the range of 0 to num_regions−1, inclusive, the following applies
   The value of guard_band_flag[i] shall be equal to 0.
   The value of packing_type[i] shall be equal to 0.
   The value of proj_reg_width[i] shall be equal to PackedPicWidth/HorDiv1.
   The value of proj_reg_height[i] shall be equal to PackedPicHeight/VerDiv1.
   The value of transform_type[i] shall be equal to 0.
   The value of packed_reg_width[i] shall be equal to PackedPicWidth/HorDiv1.
   The value of packed_reg_height[i] shall be equal to PackedPicHeight/VerDiv1.
   The value of packed_reg_top[i] shall be equal to i*PackedPicHeight*(1−1/VerDiv1).
   The value of packed_reg_left[i] shall be equal to i*PackedPicWidth*(1−1/HorDiv1).

A more detailed implementation of the third technique will now be described. The definition, syntax, and semantics of the RWP box are changed relative to the design in the first technique above as follows (where bold highlights represent additions and [[brakcets]] represent removals. The other parts remain unchanged:

The definitions can be changed as follows:

. . .
RegionWisePackingBox indicates that projected pictures are packed region-wise and require unpacking prior to rendering. The size of the projected picture is explicitly signalled in this box. The size of the packed picture is denoted as PackedPicWidth and PackedPicHeight, respectively. If the version of RegionWisePackingBox is 0, PackedPicWidth and PackedPicHeight are set equal to the width and height syntax elements, respectively, of VisualSampleEntry. Otherwise, PackedPicWidth and PackedPicHeight are set equal to the packed_picture_width and packed_picture_height syntax elements, respectively, of RegionWisePackingBox.

The syntax can be changed as follows:

```
aligned(8) class RegionWisePackingBox extends FullBox(‘rwpk’, version,
0) {
  unsigned int(16) proj_picture_width;
  unsigned int(16) proj_picture_height;
  unsigned int(16) packed_picture_width;
  unsigned int(16) packed_picture_height;
  if (version == 0)
    RegionWisePackingStruct( );
  else if (version == 1) {
    unsigned int(16) proj_picture_voffset;
    unsigned int(16) proj_picture_hoffset;
  }
}
...
```

The semantics can be changed as follows:
prof_picture_width and prof_picture_height specify the width and height, respectively, of the projected picture, in a relative unit. proj_picture_width and proj_picture_height shall both be greater than 0. In the remaining of this clause, “the relative unit” means the same relative unit as proj_picture_width and proj_picture_height.
packed_picture_width and packed_picture_height specify the width and height, respectively, of the packed picture, in the relative unit. pracked_picture_width and packed_picture_height shall both be greater than 0.
proj_picture_voffset and proj_picture_hoffset specify the vertical offset and the horizontal offset, respectively, of the packed picture in the projected picture, in the relative unit. The values shall be in the range from 0, inclusive, indicating the top-left corner of the projected picture, to proj_picture_height−PackedPicHeight−1, inclusive, and proj_picture_width−PackedPicWidth−1, inclusive, respectively.
. . .
proj_reg_width[i], proj_reg_height[i], proj_reg_top[i] and proj_reg_left[i] are indicated in the relative unit [[units of luma samples]] in a projected picture with width and height equal to proj_picture_width and proj_picture_height, respectively.
. . .
packed_reg_width[i], packed_reg_height[i], packed_reg_top[i] and packed_reg_left[i] are indicated in the relative unit [[units of luma samples]] in a packed picture with width and height equal to PackedPicWidth and PackedPicHeight, respectively.
. . .

A more detailed implementation of the third technique will now be described. The definition, syntax, and semantics of the RWP box are changed relative to the design in the first technique above as follows (where bold highlights represent additions and [[brackets]] represent removals. The other parts remain unchanged:

The definitions can be changed as follows:

. . .
RegionWisePackingBox indicates that projected pictures are packed region-wise and require unpacking prior to rendering. The size of the projected picture is explicitly signalled in this box. The size of the packed picture is denoted as PackedPicWidth and PackedPicHeight, respectively. If the version of RegionWisePackingBox is 0, PackedPicWidth and PackedPicHeight are set equal to the width and height syntax elements, respectively, of VisualSampleEntry. Otherwise, PackedPicWidth and PackedPicHeight are set equal to the packed_picture_width and packed_picture_height syntax elements, respectively, of RegionWisePackingBox.

The syntax can be changed as follows:

```
aligned(8) class RegionWisePackingBox extends FullBox(‘rwpk’, version,
0) {
  unsigned int(16) proj_picture_width;
  unsigned int(16) proj_picture_height;
  unsigned int(16) packed_picture_width;
  unsigned int(16) packed_picture_height;
  if (version == 0)
    RegionWisePackingStruct( );
  else if (version == 1) {
    unsigned int(16) proj_picture_voffset;
    unsigned int(16) proj_picture_hoffset;
  }
}
...
```

The semantics can be changed as follows:
prof_picture_width and prof_picture_height specify the width and height, respectively, of the projected picture, in a relative unit. prof_picture_width and prof_picture_height shall both be greater than 0. In the remaining of this clause, “the relative unit” means the same relative unit as proj_picture_width and proj_picture_height.
packed_picture_width and packed_picture_height specify the width and height, respectively, of the packed picture, in the relative unit. pracked_picture_width and packed_picture_height shall both be greater than 0.
. . .
proj_reg_width[i], proj_reg_height[i], proj_reg_top[i] and proj_reg_left[i] are indicated in the relative unit [[units of luma samples]] in a projected picture with width and height equal to prof_picture_width and prof_picture_height, respectively.
. . .
packed_reg_width[i], packed_reg_height[i], packed_reg_top[i] and packed_reg_left[i] are indicated in the relative unit in a packed picture with width and height equal to PackedPicWidth and PackedPicHeight, respectively.
. . .

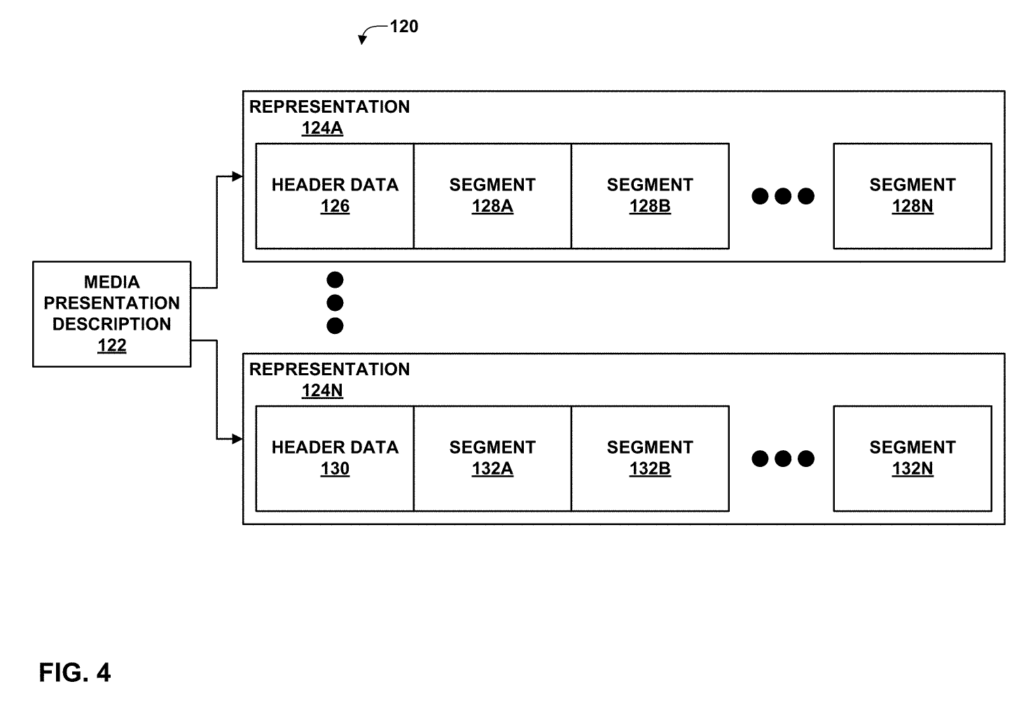

FIG. 4 is a conceptual diagram illustrating elements of example multimedia content 120. Multimedia content 120 may correspond to multimedia content 64 (FIG. 1), or another multimedia content stored in storage medium 62. In the example of FIG. 4, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 2. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 4. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

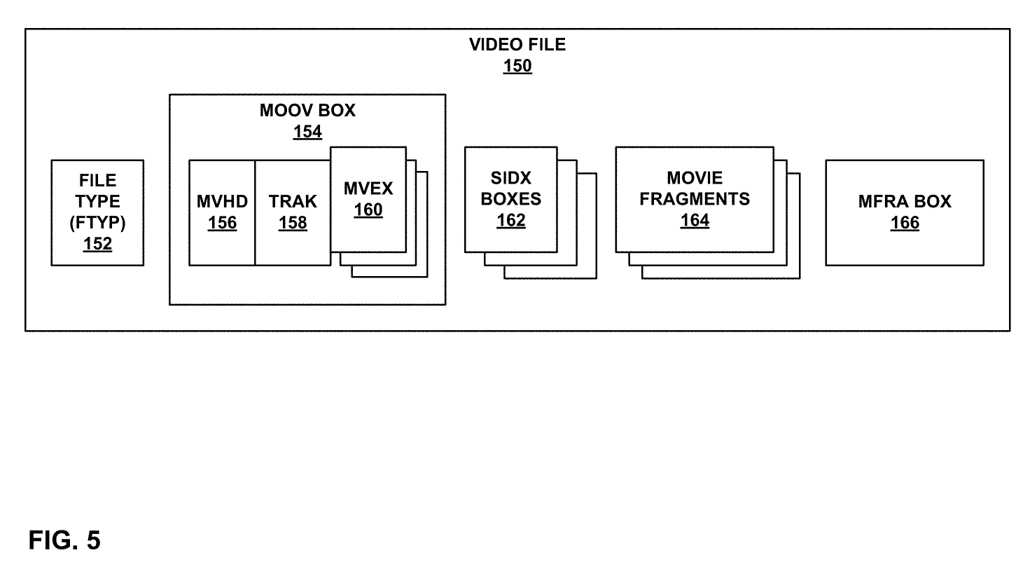

FIG. 5 is a block diagram illustrating elements of an example video file 150, which may correspond to a segment of a representation, such as one of segments 128, 132 of FIG. 4. Each of segments 128, 132 may include data that conforms substantially to the arrangement of data illustrated in the example of FIG. 5. Video file 150 may be said to encapsulate a segment. As described above, video files in accordance with the ISO base media file format and extensions thereof store data in a series of objects, referred to as “boxes.” In the example of FIG. 5, video file 150 includes file type (FTYP) box 152, movie (MOOV) box 154, segment index (sidx) boxes 162, movie fragment (MOOF) boxes 164, and movie fragment random access (MFRA) box 166. Although FIG. 5 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150. FIG. 7, discussed in greater detail below, provides additional information with respect to the MPD update box.

MOOV box 154, in the example of FIG. 5, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 4) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units which contains the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 5). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

In accordance with the techniques of this disclosure, video file 150 may further include a region-wise packing box (RWPB) including information as discussed above, e.g., within MOOV box 154. The RWPB may include an RWPB struct that defines locations of packed regions, and corresponding projected regions in a spherical video projection.

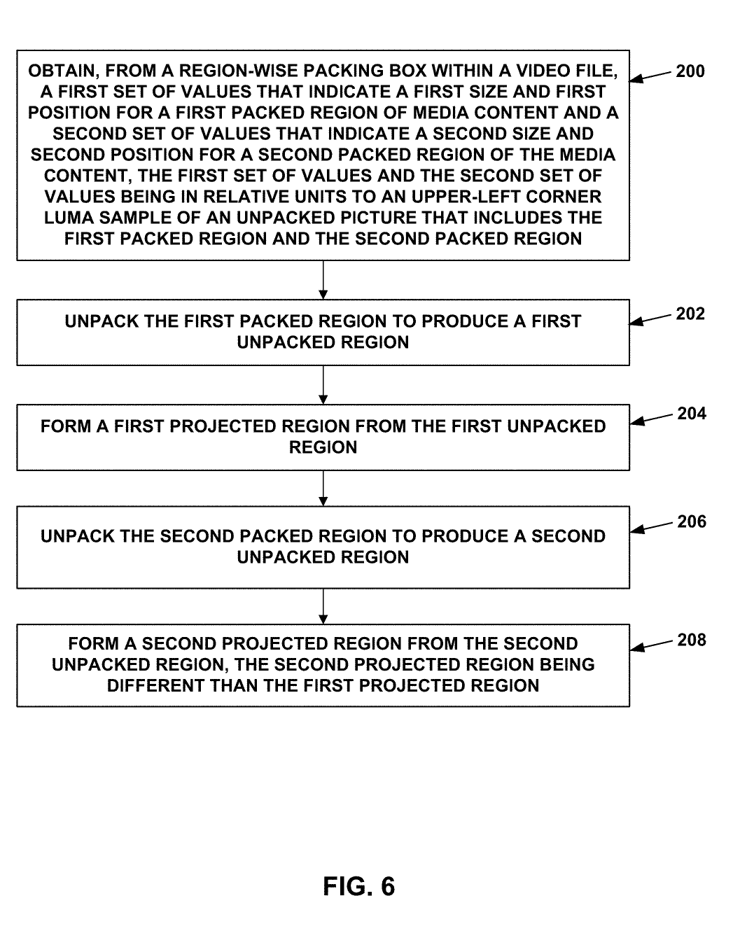

FIG. 6 is a flowchart illustrating an example method of receiving and processing media content, including video data, in accordance with the techniques of this disclosure. In general, the method of FIG. 6 is discussed with respect to client device 40 (FIG. 1). However, it should be understood that other devices may be configured to perform this or a similar method.

Client device 40 may obtain, from a region-wise packing box within a video file, a first set of values that indicate a first size and first position for a first packed region of media content and a second set of values that indicate a second size and second position for a second packed region of the media content (200). In some examples, a projected omnidirectional video box may be a container for the region-wise packing box. The first set of values and the second set of values may be in relative units to an upper-left corner luma sample of an unpacked picture that includes the first packed region and the second packed region. Client device 40 may additionally obtain from the region-wise packing box within the video file, a projected picture width and a projected picture height. The projected picture width and the projected picture height may also be in the relative units.

Client device 40 unpacks the first packed region to produce a first unpacked region (202). Client device forms a first projected region from the first unpacked region (204). Client device 40 unpacks the second packed region to produce a second unpacked region (206). Client device 40 forms a second projected region from the second unpacked region, the second projected region being different than the first projected region (208).

The first set of values may include a first width value, a first height value, a first top value, and a first left value, and wherein the second set of values comprises a second width value, a second height value, a second top value, and a second left value. Client device 40 may additionally determine a first width of the first packed region from the first width value; determine a first height of the first packed region from the first height value; determine a first top offset of the first packed region from the first top value; determine a first left offset of the first packed region from the first left value; determine a second width of the second packed region from the second width value; determine a second height of the second packed region from the second height value; determine a second top offset of the second packed region from the second top value; and determine a second left offset of the second packed region from the second left value. The first width value may, for example, be a packed_reg_width[i] value, and the first height value may be a packed_reg_height[i] value. The first top value may be a packed_reg_top[i] value, and the first left value may be a packed_reg_left[i] value. The second width value may be a packed_reg_width[j] value, and the second height value may be a packed_reg_height[j] value. The second top value may be a packed_reg_top[j] value, and the second left value may be a packed_reg_left[j] value.

The media content may be either monoscopic or stereoscopic. If the media content includes stereoscopic content, then the first packed region may correspond to a first picture of the media content, and the second packed region may correspond to a second picture of the media content.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing media content, the method comprising:
obtaining, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region;
unpacking the first packed region to produce a first unpacked region;
forming a first projected region from the first unpacked region;
unpacking the second packed region to produce a second unpacked region; and
forming a second projected region from the second unpacked region, the second projected region being different than the first projected region.

2. The method of claim 1, wherein the first set of values comprises a first width value, a first height value, a first top value, and a first left value, and wherein the second set of values comprises a second width value, a second height value, a second top value, and a second left value, the method further comprising:
determining a first width of the first packed region from the first width value;
determining a first height of the first packed region from the first height value;
determining a first top offset of the first packed region from the first top value;
determining a first left offset of the first packed region from the first left value;
determining a second width of the second packed region from the second width value;
determining a second height of the second packed region from the second height value;
determining a second top offset of the second packed region from the second top value; and
determining a second left offset of the second packed region from the second left value.

3. The method of claim 2, wherein the first width value comprises a packed_reg_width[i] value, the first height value comprises a packed_reg_height[i] value, the first top value comprises a packed_reg_top[i] value, the first left value comprises a packed_reg_left[i], the second width value comprises a packed_reg_width[j] value, the second height value comprises a packed_reg_height[j] value, the second top value comprises a packed_reg_top[j] value, and the second left value comprises a packed_reg_left[j] value.

4. The method of claim 1, further comprising:
obtaining from the region-wise packing box within the video file, a projected picture width and a projected picture height, wherein the projected picture width and the projected picture height are in the relative units.

5. The method of claim 1, wherein a container for the region-wise packing box comprises a projected omnidirectional video box.

6. The method of claim 1, wherein the media content is monoscopic.

7. The method of claim 1, wherein the media content is stereoscopic.

8. The method of claim 7, wherein the first packed region corresponds to a first picture of the media content, and wherein the second packed region corresponds to a second picture of the media content.

9. A device for processing media content, the device comprising:
a memory configured to store media content; and
one or more processors implemented in circuitry and configured to:
obtain, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region;
unpack the first packed region to produce a first unpacked region;
form a first projected region from the first unpacked region;
unpack the second packed region to produce a second unpacked region; and
form a second projected region from the second unpacked region, the second projected region being different than the first projected region.

10. The device of claim 9, wherein the first set of values comprises a first width value, a first height value, a first top value, and a first left value, and wherein the second set of values comprises a second width value, a second height value, a second top value, and a second left value, wherein the one or more processors further configured to:
determine a first width of the first packed region from the first width value;
determine a first height of the first packed region from the first height value;
determine a first top offset of the first packed region from the first top value;
determine a first left offset of the first packed region from the first left value;
determine a second width of the second packed region from the second width value;
determine a second height of the second packed region from the second height value;
determine a second top offset of the second packed region from the second top value; and
determine a second left offset of the second packed region from the second left value.

11. The device of claim 10, wherein the first width value comprises a packed_reg_width[i] value, the first height value comprises a packed_reg_height[i] value, the first top value comprises a packed_reg_top[i] value, the first left value comprises a packed_reg_left[i], the second width value comprises a packed_reg_width[j] value, the second height value comprises a packed_reg_height[j] value, the second top value comprises a packed_reg_top[j] value, and the second left value comprises a packed_reg_left[j] value.

12. The device of claim 9, wherein the one or more processors further configured to:
obtain from the region-wise packing box within the video file, a projected picture width and a projected picture height, wherein the projected picture width and the projected picture height are in the relative units.

13. The device of claim 9, wherein a container for the region-wise packing box comprises a projected omnidirectional video box.

14. The device of claim 9, wherein the media content is monoscopic.

15. The device of claim 9, wherein the media content is stereoscopic.

16. The device of claim 15, wherein the first packed region corresponds to a first picture of the media content, and wherein the second packed region corresponds to a second picture of the media content.

17. The device of claim 9, wherein the device comprises at least one of:
an integrated circuit;
a microprocessor; and
a wireless communication device.

18. The device of claim 9, wherein the device comprises a client device.

19. A computer-readable storage medium having stored thereon instructions that, when executed, cause a processor to:
obtain, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region;
unpack the first packed region to produce a first unpacked region;
form a first projected region from the first unpacked region;
unpack the second packed region to produce a second unpacked region; and
form a second projected region from the second unpacked region, the second projected region being different than the first projected region.

20. The computer-readable storage medium of claim 19, wherein the first set of values comprises a first width value, a first height value, a first top value, and a first left value, and wherein the second set of values comprises a second width value, a second height value, a second top value, and a second left value, wherein the one or more processors further configured to:
determine a first width of the first packed region from the first width value;
determine a first height of the first packed region from the first height value;
determine a first top offset of the first packed region from the first top value;
determine a first left offset of the first packed region from the first left value;
determine a second width of the second packed region from the second width value;
determine a second height of the second packed region from the second height value;
determine a second top offset of the second packed region from the second top value; and
determine a second left offset of the second packed region from the second left value.

21. The computer-readable storage medium of claim 20, wherein the first width value comprises a packed_reg_width[i] value, the first height value comprises a packed_reg_height[i] value, the first top value comprises a packed_reg_top[i] value, the first left value comprises a packed_reg_left[i], the second width value comprises a packed_reg_width[j] value, the second height value comprises a packed_reg_height[j] value, the second top value comprises a packed_reg_top[j] value, and the second left value comprises a packed_reg_left[j] value.

22. The computer-readable storage medium of claim 19, wherein the one or more processors further configured to:
obtain from the region-wise packing box within the video file, a projected picture width and a projected picture height, wherein the projected picture width and the projected picture height are in the relative units.

23. The computer-readable storage medium of claim 19, wherein a container for the region-wise packing box comprises a projected omnidirectional video box.

24. The computer-readable storage medium of claim 19, wherein the media content is monoscopic.

25. The computer-readable storage medium of claim 19, wherein the media content is stereoscopic.

26. The computer-readable storage medium of claim 25, wherein the first packed region corresponds to a first picture of the media content, and wherein the second packed region corresponds to a second picture of the media content.

27. A device for processing media content, the device comprising:
means for obtaining, from a region-wise packing box within a video file, a first set of values that indicate a first size and first position for a first packed region of media content and a second set of values that indicate a second size and second position for a second packed region of the media content, wherein the first set of values and the second set of values are in relative units to an upper-left corner luma sample of an unpacked picture comprising the first packed region and the second packed region;
means for unpacking the first packed region to produce a first unpacked region;
means for forming a first projected region from the first unpacked region;
means for unpacking the second packed region to produce a second unpacked region; and
means for forming a second projected region from the second unpacked region, the second projected region being different than the first projected region.

28. The device of claim 27, wherein the first set of values comprises a first width value, a first height value, a first top value, and a first left value, and wherein the second set of values comprises a second width value, a second height value, a second top value, and a second left value, the device further comprising:
means for determining a first width of the first packed region from the first width value;
means for determining a first height of the first packed region from the first height value;
means for determining a first top offset of the first packed region from the first top value;
means for determining a first left offset of the first packed region from the first left value;
means for determining a second width of the second packed region from the second width value;
means for determining a second height of the second packed region from the second height value;
means for determining a second top offset of the second packed region from the second top value; and
means for determining a second left offset of the second packed region from the second left value.

29. The device of claim 28, wherein the first width value comprises a packed_reg_width[i] value, the first height value comprises a packed_reg_height[i] value, the first top value comprises a packed_reg_top[i] value, the first left value comprises a packed_reg_left[i], the second width value comprises a packed_reg_width[j] value, the second height value comprises a packed_reg_height[j] value, the second top value comprises a packed_reg_top[j] value, and the second left value comprises a packed_reg_left[j] value.

30. The device of claim 27, further comprising:
obtaining from the region-wise packing box within the video file, a projected picture width and a projected picture height, wherein the projected picture width and the projected picture height are in the relative units.

31. The device of claim 27, wherein a container for the region-wise packing box comprises a projected omnidirectional video box.
